(19) United States
(12) Patent Application Publication
(10) Pub. No.: US 2026/0154572 A1
(43) Pub. Date: Jun. 4, 2026

(54) METHOD FOR CONSTRUCTING LARGE PREDICTION MODEL OF COAL BURST BASED ON MULTIMODAL DATA

(71) Applicants: China University of Mining and Technology, Xuzhou (CN); North China Institute of Science and Technology (China Coal Mine Safety Technology Training Center), Sanhe (CN)

(72) Inventors: Anye Cao, Xuzhou (CN); Yapeng Liu, Fuzhou (CN); Xu Yang, Xuzhou (CN); Dong Li, Sanhe (CN); Zhenhua Ouyang, Sanhe (CN); Tian Xu, Tai'an (CN); Yaoxin Yang, Changzhi (CN); Zhiyi Shi, Suzhou (CN)

(21) Appl. No.: 19/260,442

(22) Filed: Jul. 4, 2025

(30) Foreign Application Priority Data
Nov. 29, 2024 (CN) 2024117388412

(51) Int. Cl. G06N 5/022

(52) U.S. Cl. CPC G06N 5/022

(57) ABSTRACT

A method for constructing a large prediction model of coal burst based on multimodal data is provided. The method includes: constructing a multimodal data set by collecting data from different modalities; preprocessing the multimodal data set to construct precursor pattern sequences; and converting, according to features of different mining areas, each precursor pattern sequence into a corresponding grade form to assign a corresponding risk grade label of coal burst; processing graded precursor pattern sequences by using Transformer to predict an occurrence probability of risk grade of coal burst; evaluating, by using a comprehensive index method, risk degrees of mining information data and geological structure data, and evaluating an overall risk grade of coal burst comprehensively by combining the prediction result output by the coal burst prediction module. The method can improve applicability and prediction accuracy of the model under different mining conditions, and achieve accurate prediction of coal burst risks.

### CROSS-REFERENCE TO RELATED APPLICATION

This application claims priority to Chinese Patent Application No. 202411738841.2, filed on Nov. 29, 2024, which is herein incorporated by reference in its entirety.

### TECHNICAL FIELD

The disclosure relates to the field of coal mine monitoring and early warning technologies, more particularly to a method for constructing a coal burst model, specifically to a method for constructing a large prediction model of coal burst based on multimodal data.

### BACKGROUND

Coal burst is a typical high-energy dynamic disaster in a process of coal mining, which has characteristics of strong suddenness and great destructiveness, and is very easy to cause serious consequences such as damage to mine equipment and personal injury. An occurrence mechanism of the coal burst is complex and is affected by multiple factors such as mine geological structure, rock mass stress state, and mining depth. In recent years, with a continuous increase in the mining depth of mine resources, shallow resources have gradually been exhausted, and focus of underground mining activities has gradually shifted to deep layers. Complex geological conditions have aggravated frequency of the coal burst, and intensity of disasters has also shown an upward trend. Therefore, how to achieve accurate monitoring and early warning of the coal burst has become one of the core research issues in the field of mine safety.

Coal burst prediction involves multidisciplinary knowledge such as geology, rock mechanics, and data science. Prediction accuracy and response timeliness of the coal burst prediction are crucial to mine safety prevention and control. However, existing monitoring and early warning systems still have deficiencies in identification and prediction of impact risk sources. There are problems such as “inaccurate location of disaster sources and low early warning efficiency”, making it difficult to accurately predict coal burst risks. In addition, generalization of existing coal burst prediction models is low, and risk grade standards of different coal mines are different, which makes it difficult to directly apply the constructed models to different mining areas. Traditional prediction methods mostly rely on single modal data or expert experience, or are often limited to a specific physical indicator. They are not adaptable enough when dealing with complex geological conditions, which seriously restricts the actual prevention and control effect of the coal burst prediction models.

### SUMMARY

An objective of the disclosure is to provide a method for constructing a large prediction model of coal burst based on multimodal data. By fusing the multimodal data of the coal burst, a grade and a probability of large-energy events that may occur in the future are predicted in a time dimension. An information entropy dynamic weight calculation method designed based on time windows is combined to comprehensively evaluate a weight of the multimodal data to construct a basic large prediction model for the coal burst, thereby improving applicability and prediction accuracy of the model under different mining conditions, and achieving accurate prediction of coal burst risks.

In order to achieve the above objective, the disclosure provides a method for constructing a large prediction model of coal burst based on multimodal data, which is implemented by a multimodal data collection and preprocessing module, a coal burst prediction module and a risk grade determination module, and the method includes the following steps:
S1, constructing, by the multimodal data collection and preprocessing module, a multimodal data set by collecting data from different modalities; preprocessing, by the multimodal data collection and preprocessing module, the multimodal data set to construct precursor pattern sequences for training the prediction model; and converting, by the multimodal data collection and preprocessing module and according to features of different mining areas, each of the precursor pattern sequences into a corresponding grade form to assign a corresponding risk grade label of the coal burst for each of the precursor pattern sequences, to thereby obtain graded precursor pattern sequences;
S2, processing, by the coal burst prediction module, the graded precursor pattern sequences by using a Transformer as a core framework to output a probability distribution of risk grades of the coal burst and a prediction result, where the coal burst prediction module includes an input embedding and position encoding layer, a Transformer encoder and fully connected layers, and the input embedding and position encoding layer, the Transformer encoder and the fully connected layer are configured to work cooperatively to obtain the probability distribution of risk grades of the coal burst and the prediction result; and
S3, evaluating, by the risk grade determination module and using a comprehensive index method, risk degrees of mining information data and geological structure data independently, and evaluating, by the risk grade determination module, an overall risk grade of the coal burst comprehensively by combining the risk degrees of the mining information data and the geological structure data and the prediction result output by the coal burst prediction module; where the step S3 specifically includes:
allocating, through a weight classification method and according to a contribution ratio of each of the mining information data, the geological structure data and the prediction result in comprehensive indices, a weight of each of the mining information data, the geological structure data and the prediction result, to thereby comprehensively predict the overall risk grade of the coal burst.

In an exemplary embodiment, the method for constructing the large prediction model of coal burst based on multimodal data further includes:
in response to the overall risk grade of the coal burst greater than or equal to 0.75, sending an alarm message to a light-emitting diode (LED) display device, and controlling, by a control chip of the LED display device and based on the alarm message, an LED of the LED display device to emit red light to warn working personnel in the mine evacuate quickly.

The multimodal data set in the step S1 of the disclosure includes dynamic data composed of sensor system data and the mining information data, and static data composed of the geological structure data.

The sensor system data is collected in real-time through high-precision sensors reasonably arranged in a mine, which mainly includes microseismic monitoring waveform data, seismoacoustic waveform data, rock stress waveform data, and electromagnetic signal waveform data. The microseismic monitoring waveform data represents vibration signals resulting from stress changes in rock masses captured by an array of microseismic sensors arranged in the mine. The seismoacoustic waveform data represents small sound fluctuations in the rock masses captured by seismoacoustic sensors arranged in the mine, and the seismoacoustic waveform data reflects a dynamic change of stress in strata. The rock stress waveform data represents a dynamic change of stress in the strata collected by stress sensors arranged in the mine. The electromagnetic signal waveform data represents a change of electromagnetic signals in the strata during a stress process monitored in real-time by electromagnetic sensors arranged in the mine. Through the joint application of multiple sensing systems, high-frequency collection of the multi-dimension data is achieved, which provides multi-angle information for coal burst prediction.

The mining information data is used to describe a current mining state of the mine, and the current mining state of the mine changes continuously with a mining process, which is crucial to evaluate and predict the risk of the coal burst. The mining information data includes a minimum distance (i.e., target distance)

$${W}_{e}^{1}$$

between a mining position and an irregular working face with a knife-handle-like shape, open-off cuts of multiple working faces or an area with misaligned stop mining lines, a minimum distance

$${W}_{e}^{2}$$

between the mining position and a square area of a working face goaf, a minimum distance Wₑ³ between the mining position and a triangular roadway intersection area, a mining speed

$${W}_{e}^{4} ,$$

minimum distances between the mining position and structural features around the mine, such as a minimum distance

$${W}_{e}^{5}$$

between the mining position and a fault (a drop is greater than 3 meters, which is abbreviated as m), a minimum distance

$${W}_{e}^{6}$$

between the mining position and a fold (a tilt angle is greater than 15°), and a minimum distance

$${W}_{e}^{7}$$

between the mining position and a goaf, and a change rate

$${W}_{e}^{8}$$

of coal seam thickness at the mining position.

The geological structure data is used to describe geological factors of the mine, and evaluate the overall risk grade of the coal burst in the mine before mining. The geological structure data includes geological data and mining data. The geological data includes frequency of occurrences of the coal burst

$${W}_{1}^{1} ,$$

a mining depth

$${W}_{1}^{2} ,$$

a distance

$${W}_{1}^{3}$$

from a coal seam to a hard and thick rock layer (i.e., target rock layer) in an overlying fracture zone, a feature parameter

$${W}_{1}^{4}$$

of roof rock strata thickness, a concentration degree

$${W}_{1}^{5}$$

of a structural stress within a mining area (i.e., a ratio of the stress increment caused by the structure in the mining area to the normal stress value), an uniaxial compressive strength

$${W}_{1}^{6}$$

of coal and an elastic energy index

$${W}_{1}^{7}$$

of coal. The mining data includes a degree of pressure relief

$${W}_{2}^{1}$$

of a protective layer, a horizontal distance

$${W}_{2}^{2}$$

from a working face to a coal pillar left by mining an upper protective layer, a relationship

$${W}_{2}^{3}$$

between the working face and an adjacent goaf to the working face, a working face strength

$${W}_{2}^{4} ,$$

a width

$${W}_{2}^{5}$$

of a stage coal pillar, a thickness

$${W}_{2}^{6}$$

of reserved coal, a distance

$${W}_{2}^{7}$$

between the working face and the goaf when excavating towards the goaf, a distance

$${W}_{2}^{8}$$

between the working face and the goaf when advancing towards the goaf, a distance

$${W}_{2}^{9}$$

between the working face and the fault, a distance

$${W}_{2}^{10}$$

between the working face and the fold, and a distance

$${W}_{2}^{11}$$

between the working face and a coal seam phase transition zone.

The step S1 of the disclosure specifically includes the following steps:
S1.1, preprocessing raw data of the sensor system data to obtain denoised sensor system data, including:
   removing low-frequency or high-frequency background noise from the microseismic monitoring waveform data and the seismoacoustic waveform data by using a band-pass filtering method to obtain denoised microseismic monitoring waveform data and denoised seismoacoustic waveform data;
   removing data bias caused by sensor errors or environmental interference from the rock stress waveform data by using an outlier detection method to obtain denoised rock stress waveform data; and
   performing, by using wavelet transform, denoising processing on the electromagnetic signal waveform data to extract target electromagnetic signal components, to thereby obtain denoised electromagnetic signal waveform data;
S1.2, converting a format of the denoised sensor system data to construct the precursor pattern sequences, including:
   converting the denoised microseismic monitoring waveform data and the denoised seismoacoustic waveform data into data in a format of time-energy;
   converting the denoised rock stress waveform data into data in a format of time-stress; and
   converting the denoised electromagnetic signal waveform data into data in a format of time-magnetic field;
   where in the step S1.2, the multimodal data suitable for model training and prediction is generated, thereby providing reliable input support for subsequent modeling and analysis, and the step S1.2 specifically includes:
   recording a sensor system data set dᵢ as

$${S}_{i}^{j} ,$$

where j^{th} data of an i^{th} sensor is represented as follows:

$${d}_{i} = {S}_{i}^{j} = [ {T}_{i}^{j} , {E}_{i}^{j} ] \qquad ( 1 )$$

where dᵢ represents an i^{th} sensor system data set;

$${T}_{i}^{j}$$

represents a time corresponding to the j^{th} data of the i^{th} sensor; and

$${E}_{i}^{j}$$

represents energy, stress or magnetic field corresponding to the j^{th} data of the i^{th} sensor;
counting the sensor system data by using k time windows, where a number of the sensor system data is n; and determining a time window sequence data set

$${D}_{i}^{k}$$

of the i^{th} sensor, which is represented as follows:

$${D}_{i}^{k} = [ {d}_{i}^{1} , {d}_{i}^{2} , … , {d}_{i}^{n} ] \qquad ( 2 )$$

where

$${d}_{i}^{n}$$

represents a n^{th} data of the i^{th} sensor;
statistically analyzing the time window sequence data set

$${D}_{i}^{k}$$

to obtain a sensor data set U, where a data record

$${u}_{i}^{k}$$

of a k^{th} time window of the i^{th} sensor is represented as follows:

$${u}_{i}^{k} = [ {id}_{i}^{k} , {( {E}_{i}^{k} )}_{max} , {( {E}_{i}^{k} )}_{avg} , {f}_{i}^{k} ] \qquad ( 3 )$$

where

$$i {d}_{i}^{k}$$

represents a serial number of the k^{th} time window of the i^{th} sensor;

$${( {E}_{i}^{k} )}_{max}$$

represents maximum energy, maximum stress or maximum magnetic field of the k^{th} time window;

$${( {E}_{i}^{k} )}_{av ℊ}$$

represents average energy, average stress or average magnetic field of the k^{th} time window; and

$${f}_{i}^{k}$$

represents a frequency of the energy, the stress or the magnetic field of the k^{th} time window; and
constructing the precursor pattern sequences w according to the sensor data set U, where an e^{th} precursor pattern sequence

$${w}_{i}^{e}$$

of the i^{th} sensor is represented as follows:

$${w}_{i}^{e} = [ {u}_{i}^{e \times ℊ} , {u}_{i}^{e \times ℊ + 1} , … , {u}_{i}^{e \times ℊ + p - 1} ] \qquad ( 4 )$$

where g represents a sampling step-length; p represents a length of each of the precursor pattern sequences, and a precursor pattern sequence set Wᵢ of the i^{th} sensor is represented as follows:

$${W}_{i} = [ {w}_{i}^{0} , {w}_{i}^{1} , … , {w}_{i}^{q - 1} ] \qquad ( 5 )$$

where q represents a total number of the precursor pattern sequences; and
S1.3, standardizing sensor data in the precursor pattern sequences to obtain the graded precursor pattern sequences, where in the step S1.3, numerical data such as microseismic energy/magnetic field/stress and frequency is converted into classification information, and grades are used as model inputs instead of specific numerical values, thereby effectively improving adaptability and predictive performance of the prediction model under different mining conditions.

The input embedding and position encoding layer in the step S2 of the disclosure includes input embedding and a position encoding layer. The step S2 specifically includes:
mapping, by input embedding, each of the graded precursor pattern sequences to a high-dimension (i.e., target-dimension) space to form vectors with a preset length suitable for processing by the prediction model, including:
   performing linear variation on each input fragment xᵢ of each graded precursor pattern sequence to obtain an embedding vector eᵢ as follows:

$${e}_{i} = {W}_{e} {x}_{i} + {b}_{e} \qquad ( 6 )$$

where Wₑ represents a weight matrix of the input embedding, and bₑ represents a bias vector of the input embedding;
since the Transformer itself does not have a processing ability for position information, introducing temporal information by a position encoding layer, and generating, by the position encoding layer using a sine function and a cosine function, the position information PE_{(pos,2a)} and PE_{(pos,2a+1)} as follows:

$$P {E}_{( p o s , 2 a )} = sin ( pos / 1000 {0}^{2 a / {d}_{m o d e l}} ) \qquad ( 7 )$$

$$P {E}_{( p o s , 2 a + 1 )} = cos ( pos / 1000 {0}^{2 a / {d}_{m o del}} ) \qquad ( 8 )$$

where pos represents a position index; a represents a dimension index; d_{model} represents an embedded dimension; and
introducing, by the position encoding layer, the position information into the embedding vector eᵢ to obtain a sequence z₀ as follows:

$${z}_{0} = [ {e}_{1} + P {E}_{1} , {e}_{2} + P {E}_{2} , … , {e}_{N} + P {E}_{N} ] \qquad ( 9 )$$

where the Transformer encoder is configured to be a core part of an entire network, and configured to extract global characteristics from the sequence z₀; the coal burst prediction module is stacked by multiple encoders, and each encoder includes a multi-head self-attention mechanism, a feedforward neural network, residual connection and normalization, an output of each encoder is a high-dimension feature representation (i.e., target-dimension feature representation) that contains complex relationships between different time fragments;
where the multi-head self-attention mechanism is configured to calculate a weight of each sequence fragment in the sequence z₀, thereby dynamically capturing temporal dependence and cross modal correlation of precursor patterns of the coal burst, and effectively mining potential characteristic patterns, and the multi-head self-attention mechanism includes a self-attention mechanism and a multi-head mechanism;
in the self-attention mechanism, generating a query vector Q, a key vector K and a value vector V for the sequence z₀ for calculating a similarity weight of the sequence z₀ through a dot product operation, where the query vector Q, the key vector K and the value vector V are expressed as follows:

$$Q = {z}_{0} {W}_{Q} , K = {z}_{0} {W}_{K} , V = {z}_{0} {W}_{V} \qquad ( 10 )$$

where W_{Q}, W_{K} and W_{V} each represent a learnable weight matrix; and
calculating the similarity weight through the dot product operation, scaling the similarity weight to obtain a scaled similarity weight, and normalizing the scaled similarity weight through a Softmax activation function as follows:

$$Attention ( Q , K , V ) = Soft max ( \frac{Q {K}^{T}}{\sqrt{{d}_{k}}} ) V \qquad ( 11 )$$

where dₖ represents a dimension of the key vector; and QK^{T} represents the similarity weight, and K^{T} represents a transpose of the key vector K;
in the multi-head mechanism, calculating attention through multiple heads in parallel to increase characteristic extraction ability of the model, to thereby obtain a linearity transformation matrix, where each head has independent W_{Q}, W_{K} and W_{V}, and a formula for calculating the attention MultiHead(Q, K, V) is expressed as follows:

$$MultiHead ( Q , K , V ) = C o n c a t ( h e a {d}_{1} , … , h e a {d}_{h} ) {W}_{O} \qquad ( 12 )$$

$${head}_{h} = Attenttion ( {QW}_{Q}^{h} , K {W}_{K}^{h} , V {W}_{V}^{h} ) \qquad ( 13 )$$

where h represents a number of the plurality of heads, and W₀ represents a linearity transformation matrix; and Concat(⋅) represents a concatenating operation;
performing, by the feedforward neural network, non-linearity transform on the attention output by the multi-head self-attention mechanism, where the feedforward neural network includes a first fully connected network layer, a second fully connected network layer, and a rectified linear unit (ReLU) activation function connected between the first fully connected network layer and the second fully connected network layer, and the non-linearity transform is expressed as follows:

$$F F N ( x ) = {W}_{2} ( R e L U ( {W}_{1} x + {b}_{1} ) ) + {b}_{2} \qquad ( 14 )$$

where W₁ represents a weight matrix of a first fully connected network layer, and b₁ represents a bias vector of the first fully connected network layer; and W₂ represents a weight matrix of a second fully connected network layer, and b₂ represents a bias vector of the second fully connected network layer;
in the residual connection and normalization, adding residual connection and layer normalization after each sublayer to obtain an output Output, thereby avoiding a problem of gradient disappearance and gradient explosion as follows:

$$Output = LayerNorm ( x + S u b L a y e r ( x ) \qquad ( 15 )$$

where LayerNorm(⋅) represents layer normalization calculation; and SubLayer(x) represents an output of the multi-head self-attention mechanism or the feedforward neural network; and
in the fully connected layers, using a high-dimension feature representation Z_{L} generated by the Transformer encoder as an input of the fully connected layers, performing linearity transform on the high-dimension feature representation Z_{L} in one or multiple layers of the fully connected layers to output the probability distribution of the risk grades of the coal burst, and outputting, by using the Softmax activation function, a risk grade with a maximum probability in the probability distribution of the risk grades of the coal burst as the prediction result as follows:

$${p}_{c} = soft max ( {W}_{d} ( x ) + {b}_{d} ) \qquad ( 16 )$$

where W_{d} represents a weight matrix of an d^{th} fully connected layer of the fully connected layers, and b_{d} represents a bias vector of the d^{th} fully connected layer; and p_{c} represents a prediction probability of a risk grade c of the coal burst.

The step S3 of the disclosure specifically includes:
normalizing the risk grades RL of the coal burst into an [0,1] interval, and classifying the mining information data, the geological structure data and the prediction result into the [0,1] interval, thereby evaluating the coal burst risk, including:
   classifying the mining information data by using comprehensive index method classification criteria, where the specific criteria for classifying some factors can be modified according to an actual situation;
   calculating an influence factor Wₑ of the mining information data as follows:

$${W}_{e} = \frac{{\sum }_{i = 1}^{8} {W}_{e}^{1}}{{\sum }_{i = 1}^{8 \sum } {( {W}_{e}^{1} )}_{max}} \qquad ( 17 )$$

classifying the geological structure data by using the comprehensive index method classification criteria, and analyzing geological structures affected by the geological data and the mining data to obtain an influence factor of the geological data and an influence factor of the mining data as follows:

$${W}_{g 1} = \frac{{\sum }_{i = 1}^{7} {W}_{1}^{i}}{{\sum }_{i = 1}^{7 \sum } {( {W}_{1}^{i} )}_{max}} ; {W}_{g 2} = \frac{{\sum }_{i = 1}^{11} {W}_{2}^{i}}{{\sum }_{i = 1}^{2 \sum } {( {W}_{2}^{i} )}_{max}} \qquad ( 18 )$$

where W_{g1} represents the influence factor of the geological data, and W_{g2} represents the influence factor of the mining data;
selecting a maximum comprehensive index value of the geological data and the mining data as an influence factor W_{g} of the geological structure data as follows:

$${W}_{g} = max \{ {W}_{g 1} , {W}_{g 2} \} \qquad ( 19 )$$

using the risk grade with the maximum probability as an influence factor Wₘ of deep learning data (i.e., prediction result), including:
   determining the risk grade (none, weak, medium or strong) with the maximum probability output by the prediction model;
   classifying the maximum probability into five sub-grades, and determining four risk grade ranges corresponding to each of the five sub-grades of the maximum probability, to obtain the influence factor Wₘ of the deep learning data, thereby further improving the accuracy and practicality of the prediction.

It can be seen from analysis, the range of the maximum probability (p_{c})ₘₐₓ of the risk grade output by the prediction model is (0.25,1]. In order to show the degree of risk of different grades, the disclosure constructs different influencing factors Wₘ of the deep learning data according to a distribution characteristic of the probability output by the model. Through this classification method, each risk grade can not only reflect the probability output result of the model, but also effectively improve the classification accuracy of the risk grade, thereby achieving a more reliable risk evaluation of the coal burst.

In an exemplary embodiment, each of the multimodal data collection and preprocessing module, the coal burst prediction module, the risk grade determination module, the input embedding and position encoding layer, the Transformer encoder and the fully connected layers, the input embedding, the position encoding layer, the multi-head self-attention mechanism, the feedforward neural network, the residual connection and normalization, the self-attention mechanism and the multi-head mechanism is embodied by at least one processor and at least one memory coupled to the at least one processor, and the at least one memory stores computer programs executable by the at least one processor. Each of the multimodal data collection and preprocessing module, the coal burst prediction module, the risk grade determination module, the input embedding and position encoding layer, the Transformer encoder and the fully connected layers, the input embedding, the position encoding layer, the multi-head self-attention mechanism, the feedforward neural network, the residual connection and normalization, the self-attention mechanism and the multi-head mechanism is implemented by a corresponding algorithm and a hardware or a software.

Compared with the related art, the disclosure uses the multimodal data collection and preprocessing module and a multimodal data fusion technology to convert the raw data collected by the sensor system into the precursor pattern sequences. Compared with a method of directly using the raw data in the related art, the disclosure innovatively uses a hierarchical form to standardize the raw data, which can significantly improve the adaptability and prediction accuracy of the model under different mining conditions. In the coal burst prediction module, the model architecture based on Transformer is used. Different from the mode of directly outputting fixed results in the traditional deep learning method, the disclosure uses a probability distribution form to refine the prediction of the occurrence possibility of the risk grades of the coal burst. In the risk grade determination module, a dynamic weight calculation method based on time windows and information entropy is proposed to achieve multi-source information fusion of the mining information data, the geological structure data and the prediction result, and comprehensively evaluate the risk degree of the coal burst. The disclosure provides a method for constructing the large prediction model for the coal burst based on multimodal data. After training the basic large model on the historical data of other working faces, it can be migrated and applied to a new working face, which provides a reference for time series prediction and prevention of the coal burst, improves the applicability and the prediction accuracy of the model under different mining conditions, and achieves accurate prediction of coal burst risks.

### BRIEF DESCRIPTION OF DRAWINGS

FIG. 1 illustrates a schematic diagram of an overall architecture of a method for constructing a large prediction model of coal burst based on multimodal data according to an embodiment of the disclosure.

FIG. 2 illustrates a schematic diagram of constructing precursor pattern sequences according to an embodiment of the disclosure.

FIG. 3 illustrates a schematic diagram of a self-attention mechanism according to an embodiment of the disclosure.

FIG. 4 illustrates a schematic diagram of a multi-head self-attention mechanism according to an embodiment of the disclosure.

FIG. 5 illustrates a schematic diagram of a feedforward neural network according to an embodiment of the disclosure.

FIG. 6 illustrates a schematic diagram of residual connection and layer normalization according to an embodiment of the disclosure.

### DETAILED DESCRIPTION OF EMBODIMENTS

The disclosure will be further illustrated in conjunction with drawings.

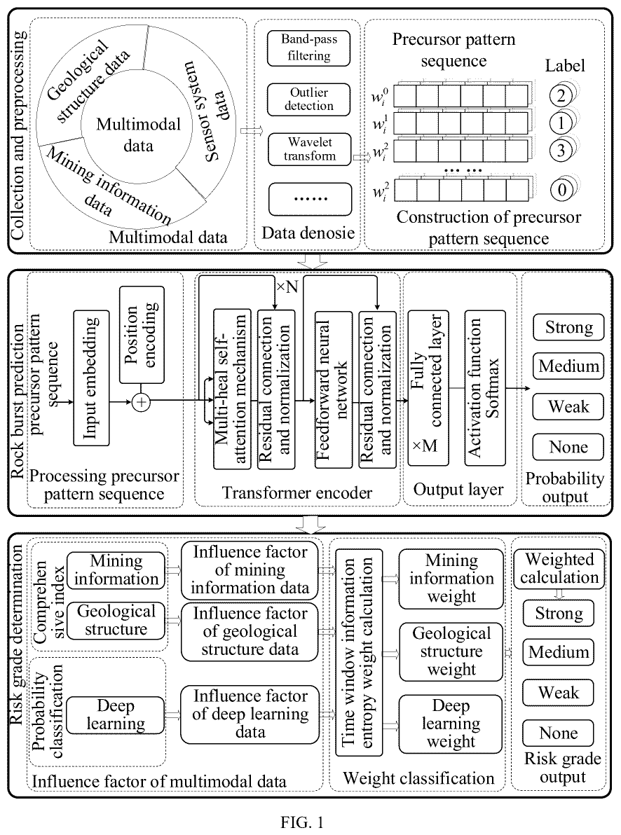

As shown in FIG. 1, a method for constructing a large prediction model of coal burst based on multimodal data is provided, which is implemented by a multimodal data collection and preprocessing module, a coal burst prediction module and a risk grade determination module. Specifically, the method includes the following steps S1-S3.

In S1, in the multimodal data collection and preprocessing module, data from different modalities is collected to construct a multimodal data set. The multimodal data set is preprocessed to construct precursor pattern sequences for model training. According to features of different mining areas, each precursor pattern sequence is converted into a corresponding grade form to assign a corresponding risk grade label of the coal burst for each precursor pattern sequence, to thereby obtain graded precursor pattern sequences.

The multimodal data set includes dynamic data composed of sensor system data and the mining information data, and static data composed of the geological structure data.

The sensor system data is collected in real-time through high-precision sensors reasonably arranged in a mine, which mainly includes microseismic monitoring waveform data, seismoacoustic waveform data, rock stress waveform data, and electromagnetic signal waveform data. The microseismic monitoring waveform data represents vibration signals resulting from stress changes in rock masses captured by an array of microseismic sensors arranged in the mine. The seismoacoustic waveform data represents small sound fluctuations in the rock masses captured by seismoacoustic sensors arranged in the mine, and the seismoacoustic waveform data reflects a dynamic change of stress in strata. The rock stress waveform data represents a dynamic change of stress in the strata collected by stress sensors arranged in the mine. The electromagnetic signal waveform data represents a change of electromagnetic signals in the strata during a stress process monitored in real-time by electromagnetic sensors arranged in the mine. Through the joint application of multiple sensing systems, high-frequency collection of the multi-dimension data is achieved, which provides multi-angle information for coal burst prediction.

The mining information data is used to describe a current mining state of the mine, and the current mining state of the mine changes continuously with a mining process, which is crucial to evaluate and predict the risk of the coal burst. The mining information data includes a minimum distance (i.e., target distance)

$${W}_{e}^{1}$$

between a mining position and an irregular working face with a knife-handle-like shape, open-off cuts of multiple working faces or an area with misaligned stop mining lines, a minimum distance

$${W}_{e}^{2}$$

between the mining position and a square area of a working face goaf, a minimum distance

$${W}_{e}^{3}$$

between the mining position and a triangular roadway intersection area, a mining speed

$${W}_{e}^{4} ,$$

minimum distances between the mining position and structural features around the mine, such as a minimum distance

$${W}_{e}^{5}$$

between the mining position and a fault (a drop is greater than 3 m), a minimum distance

$${W}_{e}^{6}$$

between the mining position and a fold (a tilt angle is greater than 15°), and a minimum distance

$${W}_{e}^{7}$$

between the mining position and a goaf, and a change rate

$${W}_{e}^{8}$$

of coal seam thickness at the mining position. The mining information data can provide basis for the change of the overall stress field of the mine, and is a key part of the multimodal data input for constructing the coal burst prediction model.

The geological structure data is used to describe geological factors of the mine, and evaluate the overall risk grade of the coal burst in the mine before mining. The geological structure data includes geological data and mining data. The geological data includes frequency of occurrences of the coal burst

$${W}_{1}^{1} ,$$

a mining depth

$${W}_{1}^{2} ,$$

a distance

$${W}_{1}^{3}$$

from a coal seam to a hard and thick rock layer (i.e., target rock layer) in an overlying fracture zone, a feature parameter

$${W}_{1}^{4}$$

of roof rock strata thickness, a concentration degree

$${W}_{1}^{5}$$

of s structural stress within a mining area, an uniaxial compressive strength

$${W}_{1}^{6}$$

of coal and an elastic energy index

$${W}_{1}^{7}$$

of coal. The mining data includes a degree of pressure relief

$${W}_{2}^{1}$$

of a protective layer, a horizontal distance

$${W}_{2}^{2}$$

from a working face to a coal pillar left by mining an upper protective layer, a relationship

$${W}_{2}^{3}$$

between the working face and an adjacent goaf to the working face, a working face strength

$${W}_{2}^{4} ,$$

a width

$${W}_{2}^{5}$$

of a stage coal pillar, a thickness

$${W}_{2}^{6}$$

of reserved coal, a distance

$${W}_{2}^{7}$$

between the working face and the goaf when excavating towards the goaf, a distance

$${W}_{2}^{8}$$

between the working face and the goaf when advancing towards the goaf, a distance

$${W}_{2}^{9}$$

between the working face and the fault, a distance

$${W}_{2}^{10}$$

between the working face and the fold, and a distance

$${W}_{2}^{11}$$

between the working face and a coal seam phase transition zone.

The step S1 specifically includes the following steps S1.1-S1.3.

In S1.1, firstly, due to large noise interference in the mine environment, the raw data of the sensor system data is preprocessed to ensure that the multimodal data has high quality when inputted into the model. Specifically, for the microseismic monitoring waveform data and the seismoacoustic waveform data, a band-pass filtering method is used to remove low-frequency or high-frequency background noise. For the rock stress waveform data, an outlier detection method is used to remove data bias caused by sensor errors or environmental interference. For the electromagnetic signal waveform data, wavelet transform is used to perform denoising processing to extract effective electromagnetic signal components.

In S1.2, secondly, a format of the denoised sensor system data is converted, so that the denoised sensor system data has consistency and is suitable for the training and prediction process of the prediction model of the coal burst. Specifically, the microseismic monitoring waveform data and the seismoacoustic waveform data are converted into data in a format of time-energy. The rock stress waveform data is converted into data in a format of time-stress. The electromagnetic signal waveform data is converted into data in a format of time-magnetic field.

Through the step S1.2, high-quality multimodal data suitable for model training and prediction needs can be generated, which provides reliable input support for subsequent modeling and analysis. Therefore, a sensor system data set dᵢ can be recorded as

$${S}_{i}^{j} ,$$

and j^{th} data of an i^{th} sensor can be represented as follows:

$${d}_{i} = {S}_{i}^{j} = [ {T}_{i}^{j} , {E}_{i}^{j} ] \qquad ( 1 )$$

where dᵢ represents an i^{th} sensor system data set;

$${T}_{i}^{j}$$

represents a time corresponding to the j^{th} data of the i^{th} sensor; and

$${E}_{i}^{j}$$

represents an energy, a stress or a magnetic field corresponding to the j^{th} data of the i^{th} sensor.

k time windows are used to count the sensor system data, and a number of the sensor system data is n. A time window sequence data set

$${D}_{i}^{k}$$

of the i^{th} sensor is determined and represented as follows:

$${D}_{i}^{k} = [ {d}_{i}^{1} , {d}_{i}^{2} , … , {d}_{i}^{n} ] \qquad ( 2 )$$

where

$${d}_{i}^{n}$$

represents a n^{th} data of the i^{th} sensor.

The time window sequence data set

$${D}_{i}^{k}$$

is statistically analyzed to obtain a sensor data set U. A data record

$${u}_{i}^{k}$$

of a k^{th} time window of the i^{th} sensor is represented as follows:

$${u}_{i}^{k} = [ i {d}_{i}^{k} , {( {E}_{i}^{k} )}_{max} , {( {E}_{i}^{k} )}_{avg} , {f}_{i}^{k} ] \qquad ( 3 )$$

where

$$i {d}_{i}^{k}$$

represents a serial number of the k^{th} time window of the i^{th} sensor;

$${( {E}_{i}^{k} )}_{max}$$

represents maximum energy, maximum stress or maximum magnetic field of the k^{th} time window;

$${( {E}_{i}^{k} )}_{a v g}$$

represents average energy, average stress or average magnetic field of the k^{th} time window; and

$${f}_{i}^{k}$$

represents a frequency of the energy, the stress or the magnetic field of the k^{th} time window.

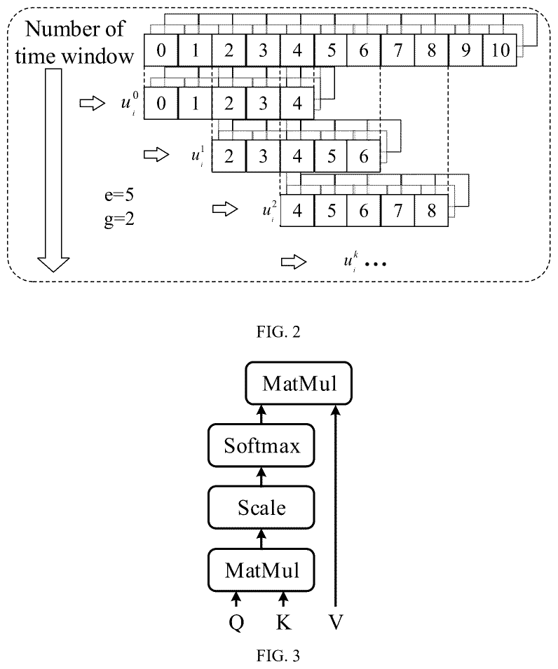

The precursor pattern sequences w are constructed according to the sensor data set U. An e^{th} precursor pattern sequence wᵢ^{e} of the i^{th} sensor is represented as follows:

$${w}_{i}^{e} = [ {u}_{i}^{e \times g} , {u}_{i}^{e \times g + 1} , … , {u}_{i}^{e \times g + p - 1} ] \qquad ( 4 )$$

where g represents a sampling step-length; p represents a length of each precursor pattern sequence, and a precursor pattern sequence set Wᵢ of the i^{th} sensor is shown as FIG. 2, and can be represented as follows:

$${W}_{i} = [ {w}_{i}^{0} , {w}_{i}^{1} , … , {w}_{i}^{q - 1} ] \qquad ( 5 )$$

where q represents a total number of the precursor pattern sequences.

In S1.3, in view of differences in the degree of risk of different mining areas under the same microseismic energy/magnetic field/stress or frequency, directly inputting the raw data into the model can easily lead to the model being unable to adapt to the specific conditions of each mining area, which shows a problem of insufficient generalization. To solve this problem, this method standardizes the sensor data in the precursor pattern sequences, converts numerical data such as microseismic energy/magnetic field/stress or frequency into classification information, and uses grades instead of specific values as model input, thereby effectively improving the adaptability and prediction performance of the model under different mining conditions.

Maximum energy and frequency in the microseismic monitoring data are taken as an example, which can be divided into different grades according to specific needs under different coal mine conditions. Table 1 shows examples of the classification of energy and frequency of the microseismic monitoring data in two coal mines. For coal mines that have not yet been mined, initial classification standards can be formulated by statistically analyzing the historical data of other working faces of the coal mine, and the classification standards can be appropriately adjusted after accumulating sufficient data.

TABLE 1
Classification information of different mines
(a) Classification information of energy of different mines

| Grade | Maximum energy E (mine A) | Maximum energy E (mine B) |
|---|---|---|
| 0 | E < 10² joules (J) | E < 10³ J |
| 1 | 10² J ≤ E < 10³ J | 10³ J ≤ E < 10⁴ J |
| 2 | 10³ J ≤ E < 10⁴ J | 10⁴ J ≤ E < 10⁵ J |
| 3 | E ≥ 10⁴ J | E ≥ 10⁵ J |

(b) Classification information of frequency of different mines

| Grade | Frequency f (mine A) | Frequency f (mine B) |
|---|---|---|
| 0 | f < 20 | f < 30 |
| 1 | 20 ≤ f < 30 | 30 ≤ f < 40 |
| 2 | 30 ≤ f < 40 | 40 ≤ f < 50 |
| 3 | f ≥ 40 | f ≥ 50 |

In addition, the definition of risk grades may vary among mines. For example, as shown in Table 2, different risk grade labels need to be set according to the actual situation of the mine and used as classification labels in subsequent model training to improve the prediction accuracy of the model in a variety of application scenarios.

TABLE 2
Classification of risk grade labels of different mines

| | Energy E | Energy E | Corresponding risk |
|---|---|---|---|
| Label | (mine A) | (min B) | grade of coal burst |
| 0 | E < 10² J | E < 10³ J | None |
| 1 | 10² J ≤ E < 10³ J | 10³ J ≤ E < 10⁴ J | Weak |
| 2 | 10³ J ≤ E < 10⁴ J | 10⁴ J ≤ E < 10⁵ J | Medium |
| 3 | E ≥ 10⁴ J | E ≥ 10⁵ J | Strong |

In S2, in the coal burst prediction module, Transformer is used as a core framework to process the graded precursor pattern sequences. The coal burst prediction module mainly includes an input embedding and position encoding layer, a Transformer encoder and fully connected layers. Each module works together to predict an occurrence probability of each risk grade of the coal burst. The step S2 specifically includes the following steps S2.1-S2.3.

In S2.1, in the input embedding and position encoding layer, the graded precursor pattern sequences are converted into high-dimension vectors suitable for Transformer processing, and position information is introduced into the precursor pattern sequences.

Specifically, the input embedding and position encoding layer includes input embedding and a position encoding layer. In the input embedding, the input sequences (i.e., the graded precursor pattern sequences) are mapped to a high-dimension space (i.e., the target-dimension space), to form vectors with a preset length suitable for processing by the prediction model. Linear variation is performed on each input fragment xᵢ of each graded precursor pattern sequence to obtain an embedding vector eᵢ as follows:

$${e}_{i} = {W}_{e} {x}_{i} + {b}_{e} \qquad ( 6 )$$

where Wₑ represents a weight matrix of the input embedding, and bₑ represents a bias vector of the input embedding.

Since Transformer itself does not have processing ability for position information, temporal information is introduced through the position encoding layer, and the position encoding layer uses a sine function and a cosine function to generate the position information PE_{(pos,2a)} and PE_{(pos,2a+1)} as follows:

$$P {E}_{( p o s , 2 a )} = sin ( pos / 1000 {0}^{2 a / {d}_{m o d e l}} ) \qquad ( 7 )$$

$$P {E}_{( p o s , 2 a + 1 )} = cos ( pos / 1000 {0}^{2 a / {d}_{m o del}} ) \qquad ( 8 )$$

where pos represents a position index; a represents a dimension index; and d_{model} represents an embedded dimension.

A sequence obtained by adding the input embedding and the position encoding layer can be represented as follows:

$${z}_{0} = [ {e}_{1} + P {E}_{1} , {e}_{2} + P {E}_{2} , … , {e}_{N} + P {E}_{N} ] \qquad ( 9 )$$

In S2.2, the Transformer encoder is a core part of an entire network, and used to extract the global characteristics from the sequence z₀. The coal burst prediction module is stacked by multiple Transformer encoders, and each Transformer encoder includes a multi-head self-attention mechanism, a feedforward neural network, and residual connection and normalization. An output of each Transformer encoder is a high-dimension feature representation that contains complex relationships between different input fragments (i.e., the time fragments). The step S12.2 specifically includes the following steps S2.2.1-S2.2.3.

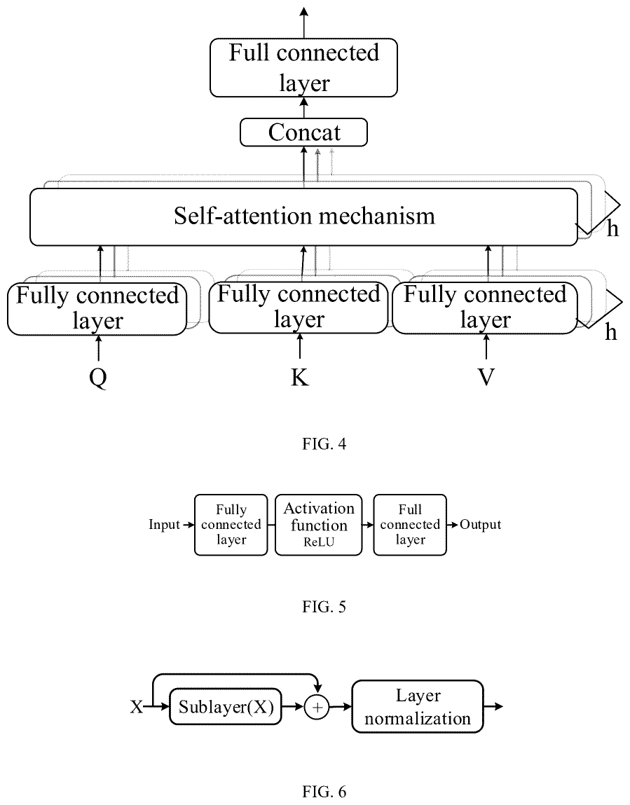

In step S2.2.1, the multi-head self-attention mechanism is as shown in FIG. 3 and FIG. 4, which is used to calculate the weight of each sequence fragment in the sequence z₀, thereby dynamically capturing temporal dependence and cross modal correlation of precursor patterns of the coal burst, and effectively mining potential characteristic patterns. The multi-head self-attention mechanism includes a self-attention mechanism and a multi-head mechanism.

The self-attention mechanism generates a query vector Q, a key vector K and a value vector V for each input sequence z₀ for calculating a similarity weight through a dot product operation (MatMul), and the query vector Q, the key vector K and the value vector V are expressed as follows:

$$Q = {z}_{0} {W}_{Q} , K = {z}_{0} {W}_{K} , V = {z}_{0} {W}_{V} \qquad ( 10 )$$

where W_{Q}, W_{K} and W_{V} each represent a learnable weight matrix.

The similarity weight is calculated through the dot product operation, and is scaled to obtain a scaled similarity weight, and the scaled similarity weight is normalized through a softmax activation function (Scale) as follows:

$$Attention ( Q , K , V ) = Softmax ( \frac{Q {K}^{T}}{\sqrt{{d}_{k}}} ) V \qquad ( 11 )$$

where dₖ represents a dimension of the key vector, which is used to prevent gradient instability caused by excessive dot product values; and QK^{T} represents the similarity weight, and K^{T} represents a transpose of the key vector K.

In order to enhance the feature extraction ability of the model, multiple heads in parallel are used to calculate attention, and each head has independent W_{Q}, W_{K} and W_{V}. A formula for calculating the attention MultiHead(Q, K, V) is expressed as follows:

$$MultiHead ( Q , K , V ) = Concat ( {head}_{1} , … , {head}_{h} ) {W}_{O} \qquad ( 12 )$$

$${head}_{h} = Attention ( {QW}_{Q}^{h} , {KW}_{K}^{h} , {VW}_{V}^{h} ) \qquad ( 13 )$$

where h represents a number of the multiple heads, and W_{O} represents an output linearity transformation matrix; and Concat(⋅) represents a concatenating operation.

In S2.2.2, the feedforward neural network is as shown in FIG. 5, the non-linearity transform is performed on the features (i.e., attention) output by the multi-head self-attention mechanism, to further improve the expression ability of the model. After the multi-head self-attention mechanism, a feature vector of each position pass through two layers of fully connected network (i.e., a first fully connected network layer and a second fully connected network layer) individually, and a ReLU activation function is added between the first fully connected network layer and the second fully connected network layer, and expressed as follows:

$$F F N ( x ) = {W}_{2} ( R e L U ( {W}_{1} x + {b}_{1} ) ) + {b}_{2} \qquad ( 14 )$$

where W₁ represents a weight matrix of a first fully connected network layer, and b₁ represents a bias vector of the first fully connected network layer; and W₂ represents a weight matrix of a second fully connected network layer, and b₂ represents a bias vector of the second fully connected network layer.

In S2.2.3, in the residual connection and normalization, in order to avoid a problem of gradient disappearance and gradient explosion, residual connection and layer normalization are added after each sublayer to obtain an output Output, as shown in FIG. 6, and a formula of the output is expressed as follows:

$$Output = LayerNorm ( x + SubLaye r ( x ) ) \qquad ( 15 )$$

where LayerNorm(⋅) represents layer normalization calculation; and SubLayer(x) represents an output of the multi-head self-attention mechanism or the feedforward neural network.

In S2.3, the high-dimension representation Z_{L} generated by the Transformer encoder is input into the fully connected layers, linearity transform is performed on the high-dimension representation Z_{L} in one or multiple layers of the fully connected layers to finally output the probability distribution of the risk grades of the coal burst. The Softmax activation function is used to output a risk grade with a maximum probability in the probability distribution of the risk grades of the coal burst as the prediction result as follows:

$${p}_{c} = softmax ( {W}_{d} ( x ) + {b}_{d} ) \qquad ( 16 )$$

where W_{d} represents a weight matrix of an d^{th} fully connected layer of the fully connected layers, and b_{d} represents a bias vector of the d^{th} fully connected layer; and p_{c} represents a prediction probability of a risk grade c of the coal burst.

In S3, in the risk grade determination module, risk degrees of the mining information data and the geological structure data are evaluated independently by using a comprehensive index method. An overall risk grade of the coal burst is evaluated comprehensively by combining the risk degrees of the mining information data and the geological structure data and the prediction result output by the coal burst prediction module and using an information entropy weight calculation method designed based on time windows. Specifically, for the mining information data, the geological structure data and the prediction result, a weight of each of the mining information data, the geological structure data and the prediction result is allocated through a weight classification method and according to a contribution ratio of each of the mining information data, the geological structure data and the prediction result in the comprehensive index method, to thereby comprehensively predict the overall risk grade of the coal burst.

Firstly, the risk grades RL of the coal burst are normalized into an [0,1] interval, as shown in Table 3. The mining information data, the geological structure data and the prediction result are classified into the [0,1] interval, which facilitates the final evaluation of the risk grades of the coal burst.

TABLE 3
Risk grades of coal burst

| Risk grade | Corresponding range of risk grade |
|---|---|
| None | 0 ≤ RL < 0.25 |
| Weak | 0.25 ≤ RL < 0.5 |
| Medium | 0.5 ≤ RL < 0.75 |
| Strong | 0.75 ≤ RL < 1 |

In S3.1, the mining information data uses comprehensive index method classification criteria, as shown in Table 4, and a specific criterion for classifying some factors can be modified according to an actual situation.

TABLE 4
Classification criteria of mining information data

| | Influence | | | Evaluation |
|---|---|---|---|---|
| Number | factor | Factor description | Factor classification | index |
| 1 | ${W}_{e}^{1}$ | Minimum distance d between a mining position | d > 60 m 40 m < d ≤ 60 m | 0 1 |
| | | and an irregular working | 20 m < d ≤ 40 m | 2 |
| | | face with a knife-handle- | d ≤ 20 m | 3 |
| | | like shape, open-off cuts of | | |
| | | multiple working faces or | | |
| | | an area with misaligned | | |
| | | stop mining lines | | |
| 2 | ${W}_{e}^{2}$ | Minimum distance dⱼ between the mining | dⱼ > 100 m 75 m < dⱼ ≤ 100 m | 0 1 |
| | | position and a square area | 50 m < dⱼ ≤ 75 m | 2 |
| | | of a working face goaf | dⱼ ≤ 50 m | 3 |
| 3 | ${W}_{e}^{3}$ | Minimum distance dₜ between the mining | dₜ > 50 m 30 m < dₜ ≤ 50 m | 0 1 |
| | | position and a triangular | 10 m < dₜ ≤ 30 m | 2 |
| | | roadway intersection area | dₜ ≤ 10 m | 3 |
| 4 | ${W}_{e}^{4}$ | Mining speed V | V ≤ 2.4 meters per day (m/d) 2.4 m/d < V ≤ 4m/d | 0 1 |
| | | | 4 m/d < V ≤ 6.4 m/d | 2 |
| | | | V > 6.4 m/d | 3 |
| 5 | ${W}_{e}^{5}$ | Minimum distance d_{f} between the mining | d_{f} > 50 m 30 m < d_{f} ≤ 50 m | 0 1 |
| | | position and fault (a drop is | 10 m < d_{f} ≤ 30 m | 2 |
| | | greater than 3 m) | d_{f} ≤ 10 m | 3 |
| 6 | ${W}_{e}^{6}$ | Minimum distance dₚ between the mining | dₚ > 50 m 30 m < dₚ ≤ 50 m | 0 1 |
| | | position and fold (a tilt | 10 m < dₚ ≤ 30 m | 2 |
| | | angle is greater than 15°) | dₚ ≤ 10 m | 3 |
| 7 | ${W}_{e}^{7}$ | Minimum distance dₛ between the mining | dₛ >150 m 100 m < dₛ ≤ 150 m | 0 1 |
| | | position and goaf | 50 m < dₛ ≤ 100 m | 2 |
| | | | d ≤ 50 m | 3 |
| 8 | ${W}_{e}^{8}$ | Change rate γ of coal seam thickness (relative to | 0 ≤ γ < 25% 25% ≤ γ < 50% | 0 1 |
| | | average coal thickness) at | 50% ≤ γ < 75% | 2 |
| | | the mining position | γ ≥ 75% | 3 |

An influence factor Wₑ of the mining information data is calculated as follows:

$${W}_{e} = \frac{{\sum }_{i = 1}^{8} {W}_{e}^{1}}{{\sum }_{i = 1}^{8 \sum } {( {W}_{e}^{1} )}_{max}} . \qquad ( 17 )$$

In S3.2, the geological structure data uses the comprehensive index method classification criteria as shown in Table 5.

TABLE 5
Classification criteria of geological structure data

| | | | | |
|---|---|---|---|---|
| | Influence | | | Evaluation |
| Number | factor | Factor description | Factor classification | index |

(a) Classification criteria of geological structure data affected by geological data

| | | | | |
|---|---|---|---|---|
| 1 | ${W}_{1}^{1}$ | Coal burst of coal seams at the same grade | n = 0 n = 1 | 0 1 |
| | | The frequency of | n = 2 | 2 |
| | | occurrences (number/n) | n > 3 | 3 |
| 2 | ${W}_{1}^{2}$ | Mining depth h | h ≤ 400 m 400 m < h ≤ 600 m | 0 1 |
| | | | 600 m < h ≤ 800 m | 2 |
| | | | h > 800 m | 3 |
| 3 | ${W}_{1}^{3}$ | Distance (d/m) from a coal seam to a hard and thick | d > 100 m 50 m < d ≤ 100 m | 0 1 |
| | | rock layer in an overlying | 20 m < d ≤ 50 m | 2 |
| | | fracture zone | d ≤ 20 m | 3 |
| 4 | ${W}_{1}^{4}$ | Feature parameter Lₛₜ of roof rock strata thickness | Lₛₜ ≤ 50 m 50 m < Lₛₜ ≤ 70 m | 0 1 |
| | | | 70 m < Lₛₜ ≤ 90 m | 2 |
| | | | Lₛₜ > 90 m | 3 |
| 5 | ${W}_{1}^{5}$ | Ratio γ = (σ_{g} − σ)/σ of the stress increment caused | γ ≤ 10% 10% < γ ≤ 20% | 0 1 |
| | | by the structure in the | 20% < γ ≤ 30% | 2 |
| | | mining area to the normal | γ > 30% | 3 |
| | | stress value | | |
| 6 | ${W}_{1}^{6}$ | Uniaxial compressive strength R_{c} of coal | R_{c} ≤ 10 megapascals (MPa) 10 Mpa < R_{c} ≤ 14 MPa | 0 1 |
| | | | 14 Mpa < R_{c} ≤ 20 MPa | 2 |
| | | | R_{c} > 20 MPa | 3 |
| 7 | ${W}_{1}^{7}$ | Elastic energy index W_{ET} of coal | W_{ET} < 2 2 ≤ W_{ET} < 3.5 | 0 1 |
| | | | 3.5 ≤ W_{ET} < 5 | 2 |
| | | | W_{ET} ≥ 5 | 3 |

(b) Classification criteria of geological structure data affected by mining data

| | | | | |
|---|---|---|---|---|
| 1 | ${W}_{2}^{1}$ | Degree of pressure relief of a protective layer | Good Medium | 0 1 |
| | | | Normal | 2 |
| | | | Poor | 3 |
| 2 | ${W}_{2}^{2}$ | Horizontal distance hz from a working face to a | hz ≥ 60 m 30 m ≤ hz < 60 m | 0 1 |
| | | coal pillar left by mining | 0 m ≤ hz < 30 m | 2 |
| | | an upper protective layer | hz < 0 m (under the coal pillar) | 3 |
| 3 | ${W}_{2}^{3}$ | Relationship between working face with | Solid coal working face One side goaf | 0 1 |
| | | adjacent goaf | two side goaf | 2 |
| | | | Three side or more goaf | 3 |
| 4 | ${W}_{2}^{4}$ | Working face length Lm | Lm ≥ 300 m 150 m ≤ Lm < 300 m | 0 1 |
| | | | 100 m ≤ Lm < 150 m | 2 |
| | | | Lm < 100 m | 3 |
| 5 | ${W}_{2}^{5}$ | Width d of a stage coal pillar | d ≤ 3 m, or d ≥ 50 m 3 m < d ≤ 6 m | 0 1 |
| | | | 6 m < d ≤ 10 m | 2 |
| | | | 10 m < d < 50 m | 3 |
| 6 | ${W}_{2}^{6}$ | Thickness td of reserved coal | td = 0 m 0 m < td ≤ 1 m | 0 1 |
| | | | 1 m < td ≤ 2 m | 2 |
| | | | td > 2 m | 3 |
| 7 | ${W}_{2}^{7}$ | The roadway excavated towards the goaf, with the | Ljc ≥ 150 m 100 m ≤ Ljc < 150 m | 0 1 |
| | | excavation head | 50 m ≤ Ljc < 100 m | 2 |
| | | approaching the distance | Ljc < 50 m | 3 |
| | | Ljc from the goaf | | |
| 8 | ${W}_{2}^{8}$ | The working face advancing towards the | Lmc ≥ 300 m 200 m ≤ Lmc < 300 m | 0 1 |
| | | goaf, the distance Lmc | 100 m ≤ Lmc < 200 m | 2 |
| | | from the working face to | Lmc < 100 m | 3 |
| | | the goaf | | |
| 9 | ${W}_{2}^{9}$ | A working face or roadway that advances | Ld ≥ 100 m 50 m ≤ Ld < 100 m | 0 1 |
| | | towards a fault with a | 20 m ≤ Ld < 50 m | 2 |
| | | drop greater than 3 m, at | Ld < 20 m | 3 |
| | | a distance Ld close to the | | |
| | | fault | | |
| 10 | ${W}_{2}^{10}$ | A working face or roadway that advances | Lz ≥ 50 m 20 m ≤ Lz < 50 m | 0 1 |
| | | towards a significant | 10 m ≤ Lz < 20 m | 2 |
| | | change in coal seam dip | Lz <10 m | 3 |
| | | angle (>15°) and | | |
| | | approaches the distance | | |
| | | Lz of the fold | | |
| 11 | ${W}_{2}^{11}$ | The work or roadway that advances towards the | Lb ≥ 50 m 20 m ≤ Lb < 50 m | 0 1 |
| | | erosion, layering, or | 10 m ≤ Lb < 20 m | 2 |
| | | thickness changes of the | Lb < 10 m | 3 |
| | | coal seam, close to the | | |
| | | distance Lb of the coal | | |
| | | seam changes | | |

The comprehensive index method is used to analyze the geological structures affected by the above geological data and the mining data to obtain an influence factor of the geological data and an influence factor of the mining data as follows:

$${W}_{g 1} = \frac{{\sum }_{i = 1}^{7} {W}_{1}^{i}}{{\sum }_{i = 1}^{7 \sum } {( {W}_{1}^{i} )}_{max}} ; {W}_{g 2} = \frac{{\sum }_{i = 1}^{11} {W}_{2}^{i}}{{\sum }_{i = 1}^{2 \sum } {( {W}_{2}^{i} )}_{max}} \qquad ( 18 )$$

where W_{g1} represents the influence factor of the geological data, and W_{g2} represents the influence factor of the mining data.

A maximum comprehensive index value of the geological data and the mining data is selected as an influence factor W_{g} of the geological structure data as follows:

$${W}_{g} = max \{ {W}_{g 1} , {W}_{g 2} \} . \qquad ( 19 )$$

In S3.3, traditional deep learning models usually use a maximum value of the model output category probability as the prediction result. When the maximum probability is high, the model's credibility for its output result is relatively high. However, when the probabilities of multiple categories are close, the model's determination on category attribution may be uncertain, thereby reducing the reliability of the prediction result. In response to this problem, the disclosure proposes a method that comprehensively considers the maximum probability of the model output and the risk grades of the coal burst. Firstly, a corresponding risk grade (none, weak, medium, or strong) is determined according to the maximum probability output by the model, and the maximum probability is further divided into five sub-grades. Then, a range of the determined risk grade (as shown in Table 3) is divided into 5 refined risk degree values corresponding to the five sub-grade ranges of the maximum probability. Finally, according to the range of the maximum probability, the risk degree value is determined as an influencing factor Wₘ of deep learning data to improve the accuracy and practicality of the prediction.

Therefore, the disclosure proposes a method for comprehensively considering the maximum probability output by the prediction model and the risk grades of the coal burst. Firstly, the risk grade (none, weak, medium, strong) with the maximum probability output by the prediction model is determined. Then, the maximum probability is divided into 5 sub-grades, and 4 risk grade ranges corresponding to each of the five sub-grades of the maximum probability are determined. Therefore, the risk grade is output as the influencing factor of deep learning data (i.e., the prediction result), further improving the accuracy and practicality of prediction.

It can be seen from analysis, the range of the maximum probability (p_{c})ₘₐₓ of the risk grade output by the model is (0.25,1]. In order to show the degree of risk of different grades, the disclosure constructs different influencing factors Wₘ of the deep learning data according to a distribution characteristic of the probability output by the model, and the specific classification standards are shown in Table 6. Through this classification method, each risk grade can not only reflect the probability output result of the model, but also effectively improve the classification accuracy of the risk grade, thereby achieving a more reliable risk evaluation of coal burst.

TABLE 6
Output criteria of the influencing factors of the deep learning data

| | | Influence factor Wₘ of | | | |
|---|---|---|---|---|---|
| | | deep learning data | | | |
| | | None | Weak | Medium | Strong |
| Maximum | 0.25 < (p_{c})ₘₐₓ ≤ 0.4 | 0.05 | 0.3 | 0.55 | 0.8 |
| probability | 0.4 < (p_{c})ₘₐₓ ≤ 0.55 | 0.1 | 0.35 | 0.6 | 0.85 |
| (p_{c})ₘₐₓ | 0.55 < (p_{c})ₘₐₓ ≤ 0.7 | 0.15 | 0.4 | 0.65 | 0.9 |
| output by | 0.7 < (p_{c})ₘₐₓ ≤ 0.85 | 0.2 | 0.45 | 0.7 | 0.95 |
| the model | 0.85 < (p_{c})ₘₐₓ ≤ 1 | 0.25 | 0.5 | 0.75 | 1 |

In order to further comprehensively evaluate the degree of risk of the coal burst, the disclosure proposes an information entropy weight calculation method designed based on time windows. The influence factor Wₑ of the mining information data, the influence factor W_{g} of the geological structure data and the influence factor Wₘ of the deep learning data are comprehensively considered, and weight classification is adopted to determine a weight aₑ of the influence factor Wₑ of the mining information data, a weight a_{g} of the influence factor W_{g} of the geological structure data and a weight aₘ of the influence factor Wₘ of the deep learning data, and aₑ+a_{g}+aₘ=1.

Firstly, considering that the weights should change dynamically with the mining process, the same time windows as the precursor pattern sequences are used to count the three types of data, and the probability distribution of each type of data is calculated as follows:

$${P}_{k l} = \frac{{W}_{k} ( l )}{{\sum }_{l = 1}^{b} {W}_{k} ( l )} , k ∈ \{ e , g , m \} , l ∈ 1 , 2 , … , b \qquad ( 20 )$$

where Wₖ(l) represents an influence factor of the mining information data, an influence factor of the geological structure data and an influence factor of the deep learning data of a l^{th} sample of samples; and b represents a total number of the samples.

Then, an information entropy of each type of data is calculated as follows:

$${E}_{k} = - \frac{1}{ln ( b )} {\sum }_{l = 1}^{b} {P}_{k l} ln ( {P}_{k l} ) , k ∈ \{ e , g , m \} \qquad ( 21 )$$

where Eₖ represents an information entropy of a k^{th} type of data; and ln(b) represents a normalization coefficient of the information entropy; and e represents the mining information data, g represents the geological structure data, and m represents the deep learning data.

Therefore, a calculation formula of a weight of each part is as follows:

$${α}_{k} = \frac{1 - {E}_{k}}{{\sum }_{k = 1}^{3} ( 1 - {E}_{k} )} , k ∈ \{ e , g , m \} \qquad ( 22 )$$

where aₑ represents the weight of the influence factor Wₑ of the mining information data, ay represents the weight of the influence factor W_{g} of the geological structure data, and aₘ represents the weight of the influence factor Wₘ of the deep learning data.

Finally, the risk grades RL in a prediction time interval is calculated as follows:

$$RL = {α}_{e} {W}_{e} + {α}_{g} {W}_{g} + {α}_{m} {W}_{m} . \qquad ( 23 )$$

Table 3 is used to determine the degree of risk RL (none, weak, medium or strong) in the prediction time interval, thereby predicting the risk of the coal burst.

1. A method for constructing a prediction model of coal burst based on multimodal data, wherein the method is implemented by a multimodal data collection and preprocessing module, a coal burst prediction module and a risk grade determination module, and the method comprises the following steps:
S1, constructing, by the multimodal data collection and preprocessing module, a multimodal data set by collecting data from different modalities; preprocessing, by the multimodal data collection and preprocessing module, the multimodal data set to construct precursor pattern sequences for training the prediction model; and converting, by the multimodal data collection and preprocessing module and according to features of different mining areas, each of the precursor pattern sequences into a corresponding grade form to assign a corresponding risk grade label of the coal burst for each of the precursor pattern sequences, to thereby obtain graded precursor pattern sequences;
S2, processing, by the coal burst prediction module, the graded precursor pattern sequences by using a Transformer as a core framework to output a probability distribution of risk grades of the coal burst and a prediction result, wherein the coal burst prediction module comprises an input embedding and position encoding layer, a Transformer encoder and fully connected layers, and the input embedding and position encoding layer, the Transformer encoder and the fully connected layers are configured to work cooperatively to obtain the probability distribution of risk grades of the coal burst and the prediction result; and
S3, evaluating by the risk grade determination module and using a comprehensive index method, risk degrees of mining information data and geological structure data independently, and evaluating, by the risk grade determination module, an overall risk grade of the coal burst comprehensively by combining the risk degrees of the mining information data and the geological structure data and the prediction result output by the coal burst prediction module; wherein the step S3 specifically comprises:
allocating, through a weight classification method and according to a contribution ratio of each of the mining information data, the geological structure data and the prediction result in comprehensive indices, a weight of each of the mining information data, the geological structure data and the prediction result, to thereby comprehensively predict the overall risk grade of the coal burst.

2. The method for constructing the prediction model of the coal burst based on multimodal data as claimed in claim 1, wherein the multimodal data set in the step S1 comprises dynamic data composed of sensor system data and the mining information data, and static data composed of the geological structure data;
wherein the sensor system data is collected in real-time through sensors arranged in a mine, and the sensor system data comprises microseismic monitoring waveform data, seismoacoustic waveform data, rock stress waveform data, and electromagnetic signal waveform data; the microseismic monitoring waveform data represents vibration signals resulting from stress changes in rock masses captured by an array of microseismic sensors arranged in the mine; the seismoacoustic waveform data represents sound fluctuations in the rock masses captured by seismoacoustic sensors arranged in the mine, and the seismoacoustic waveform data reflects a dynamic change of stress in strata; the rock stress waveform data represents a dynamic change of stress in the strata collected by stress sensors arranged in the mine; the electromagnetic signal waveform data represents a change of electromagnetic signals in the strata during a stress process monitored in real-time by electromagnetic sensors arranged in the mine; and the microseismic sensors, the seismoacoustic sensors, the stress sensors and the electromagnetic sensors are configured to be cooperatively applied to achieve collection of multi-dimension data, and provide multi-angle information for prediction of the coal burst;
wherein the mining information data is configured to describe a current mining state of the mine, and the current mining state of the mine is configured to change continuously with a mining process; the mining information data comprises a minimum distance
$${W}_{e}^{1}$$
between a mining position and an irregular working face with a knife-handle-like shape, open-off cuts of a plurality of working faces or an area with misaligned stop mining lines, a minimum distance
$${W}_{e}^{2}$$
between the mining position and a square area of a working face goaf, a minimum distance
$${W}_{e}^{3}$$
between the mining position and a triangular roadway intersection area, a mining speed
$${W}_{e}^{4} ,$$
minimum distances between the mining position and structural features around the mine and a change rate of coal seam thickness at the mining position
$${W}_{e}^{8} ,$$
and the minimum distances between the mining position and the structural features around the mine comprise a minimum distance
$${W}_{e}^{6}$$
between the mining position and a fault, a minimum distance
$${W}_{e}^{5}$$
between the mining position and a fold, and a minimum distance
$${W}_{e}^{7}$$
between the mining position and a goaf; and
wherein the geological structure data is configured to describe geological factors of the mine, and evaluate the overall risk grade of the coal burst in the mine before mining; the geological structure data comprises geological data and mining data; the geological data comprises a frequency of occurrences of the coal burst
$${W}_{1}^{1} ,$$
a mining depth
$${W}_{1}^{2} ,$$
a distance
$${W}_{1}^{3}$$
from a coal seam to a target rock layer in an overlying fracture zone, a feature parameter
$${W}_{1}^{4}$$
of roof rock thickness, a concentration degree
$${W}_{1}^{5}$$
of a structural stress within a mining area, an uniaxial compressive strength
$${W}_{1}^{6}$$
of coal and an elastic energy index
$${W}_{1}^{7}$$
of coal; and the mining data comprises a degree of pressure relief
$${W}_{2}^{1}$$
of a protective layer, a horizontal distance
$${W}_{2}^{2}$$
from a working face to a coal pillar left by mining an upper protective layer, a relations
$${W}_{2}^{3}$$
between the working face and an adjacent goaf to the working face, a working face strength
$${W}_{2}^{4} ,$$
a width
$${W}_{2}^{5}$$
of a stage pillar, a thickness
$${W}_{2}^{6}$$
of reserved coal, a distance
$${W}_{2}^{7}$$
between the working face and the goaf when excavating towards the goaf, a distance
$${W}_{2}^{8}$$
between the working face and the goaf when advancing towards the goaf, a distance
$${W}_{2}^{9}$$
between the working face and the fault, a distance
$${W}_{2}^{10}$$
between the working face and the fold, and a distance
$${W}_{2}^{11}$$
between the working face and a coal seam phase transition zone.

3. The method for constructing the prediction model of the coal burst based on multimodal data as claimed in claim 2, wherein the step S1 specifically comprises the following steps:
S1.1, preprocessing raw data of the sensor system data to obtain denoised sensor system data, comprising:
removing low-frequency or high-frequency background noise from the microseismic monitoring waveform data and the seismoacoustic waveform data by using a band-pass filtering method to obtain denoised microseismic monitoring waveform data and denoised seismoacoustic waveform data;
removing data bias caused by sensor errors or environmental interference from the rock stress waveform data by using an outlier detection method to obtain denoised rock stress waveform data; and
performing, by using wavelet transform, denoising processing on the electromagnetic signal waveform data to extract target electromagnetic signal components, to thereby obtain denoised electromagnetic signal waveform data;
S1.2, converting a format of the denoised sensor system data to construct the precursor pattern sequences, comprising:
converting the denoised microseismic monitoring waveform data and the denoised seismoacoustic waveform data into data in a format of time-energy;
converting the denoised rock stress waveform data into data in a format of time-stress; and
converting the denoised electromagnetic signal waveform data into data in a format of time-magnetic field;
wherein in the step S1.2, the multimodal data suitable for model training and prediction is generated, thereby providing reliable input support for subsequent modeling and analysis, and the step S1.2 specifically comprises:
recording a sensor system data set dᵢ as
$${S}_{i}^{j} ,$$
wherein j^{th} data of an i^{th} sensor is represented as follows:
$${d}_{i} = {S}_{i}^{j} = [ {T}_{i}^{j} , {E}_{i}^{j} ] \qquad ( 1 )$$
wherein dᵢ represents an i^{th} sensor system data set;
$${T}_{i}^{j}$$
represents a time corresponding to the j^{th} data of the i^{th} sensor; and
$${E}_{i}^{j}$$
represents energy, stress or magnet field corresponding to the j^{th} data of the i^{th} sensor;
counting the sensor system data by using k time windows, where a number of the sensor system data is n; and determining a time window sequence data set
$${D}_{i}^{k}$$
of the i^{th} sensor, which is represented as follows:
$${D}_{i}^{k} = [ {d}_{i}^{1} , {d}_{i}^{2} , ... , {d}_{i}^{n} ] \qquad ( 2 )$$
wherein
$${d}_{i}^{n}$$
represents a n^{th} data of the i^{th} sensor;
statistically analyzing the time window sequence data set
$${D}_{i}^{k}$$
to obtain a sensor data set U, wherein a data record
$${u}_{i}^{k}$$
of a k^{th} time window of the i^{th} sensor is represented as follows:
$${u}_{i}^{k} = [ {id}_{i}^{k} , {( {E}_{i}^{k} )}_{max} , {( {E}_{i}^{k} )}_{avg} , {f}_{i}^{k} ] \qquad ( 3 )$$
wherein
$${id}_{i}^{k}$$
represents a serial number of the k^{th} time window of the i^{th} sensor;
$${( {E}_{i}^{k} )}_{max}$$
represents maximum energy, maximum stress or maximum magnetic field of the k^{th} time window;
$${( {E}_{i}^{k} )}_{avg}$$
represents average energy, average stress or average magnetic field of the k^{th} time window; and
$${f}_{i}^{k}$$
represents a frequency of the energy, the stress or the magnetic field of the k^{th} time window; and
constructing the precursor pattern sequences w according to the sensor data set U, wherein an e^{th} precursor pattern sequence
$${w}_{i}^{e}$$
of the i^{th} sensor is represented as follows:
$${w}_{i}^{e} = [ {u}_{i}^{e \times g} , {u}_{i}^{e \times g + 1} , ... , {u}_{i}^{e \times g + p - 1} ] \qquad ( 4 )$$
wherein g represents a sampling step-length, p represents a length of each of the precursor pattern sequences, and a precursor pattern sequence set Wᵢ of the i^{th} sensor is represented as follows:
$${W}_{i} = [ {w}_{i}^{0} , {w}_{i}^{1} , ... , {w}_{i}^{q - 1} ] \qquad ( 5 )$$
wherein q represents a total number of the precursor pattern sequences; and
S1.3, standardizing sensor data in the precursor pattern sequences to obtain the graded precursor pattern sequences, wherein in the step S1.3, numerical data of microseismic energy, magnetic field or stress and frequency is converted into classification information, and the risk grades are used as model inputs instead of the numerical data, thereby improving adaptability and predictive performance of the prediction model under different mining conditions.

4. The method for constructing the prediction model of the coal burst based on multimodal data as claimed in claim 2, wherein the step S2 specifically comprises the following steps:
S2.1, in the input embedding and position encoding layer, mapping, by input embedding, each of the graded precursor pattern sequences to a target-dimension space to form vectors with a preset length suitable for processing by the prediction model, comprising:
performing linear variation on each input fragment xᵢ of each of the graded precursor pattern sequences to obtain an embedding vector eᵢ as follows:
$${e}_{i} = {W}_{e} {x}_{i} + {b}_{e} \qquad ( 6 )$$
wherein Wₑ represents a weight matrix of the input embedding, and bₑ represents a bias vector of the input embedding;
introducing temporal information by a position encoding layer since the Transformer does not have a processing ability for position information, and generating, by the position encoding layer using a sine function and a cosine function, the position information PE_{(pos,2a)} and PE_{(pos,2a+1)} as follows:
$${PE}_{( pos , 2 a )} = sin ( pos / {10000}^{2 a / {d}_{model}} ) \qquad ( 7 )$$
$${PE}_{( pos , 2 a + 1 )} = cos ( pos / {10000}^{2 a / {d}_{model}} ) \qquad ( 8 )$$
wherein pos represents a position index; a represents a dimension index; and d_{model} represents an embedded dimension; and
introducing, by the position encoding layer, the position information into the embedding vector eᵢ to obtain a sequence z₀ as follows:
$${z}_{0} = [ {e}_{1} + {PE}_{1} , {e}_{2} + {PE}_{2} , … , {e}_{N} + {PE}_{N} ] \qquad ( 9 )$$
S2.2, in the Transformer encoder, extracting global characteristics from the sequence z₀ obtained in the step S2.1 to obtain a target-dimension feature representation, wherein the Transformer encoder is configured to be a core part of the prediction model, the coal burst prediction module is stacked by multiple Transformer encoders, each of the Transformer encoders comprises a multi-head self-attention mechanism, a feedforward neural network, and residual connection and normalization; the step S2.2 comprises:
S2.2.1, calculating, by the multi-head self-attention mechanism, a weight of each sequence fragment in the sequence z₀, thereby dynamically capturing temporal dependence and cross modal correlation of precursor patterns of the coal burst, and mining potential characteristic patterns, wherein the multi-head self-attention mechanism comprises a self-attention mechanism and a multi-head mechanism, and the step S2.2.1 specifically comprises:
in the self-attention mechanism, generating a query vector Q, a key vector K and a value vector V for the sequence z₀ for calculating a similarity weight of the sequence z₀ through a dot product operation, wherein the query vector Q, the key vector K and the value vector V are expressed as follows:
$$Q = {z}_{0} {W}_{Q} , K = {z}_{0} {W}_{K} , V = {z}_{0} {W}_{V} \qquad ( 10 )$$
wherein W_{Q}, W_{K} and W_{V} each represent a learnable weight matrix; and
calculating the similarity weight through the dot product operation, scaling the similarity weight to obtain a scaled similarity weight, and normalizing the scaled similarity weight through a Softmax activation function as follows:
$$Attention ( Q , K , V ) = Softmax ( \frac{{QK}^{T}}{\sqrt{{d}_{k}}} ) V \qquad ( 11 )$$
wherein dₖ represents a dimension of the key vector; and QK^{T} represents the similarity weight, and K^{T} represents a transpose of the key vector K;
in the multi-head mechanism, calculating attention through a plurality of heads in parallel to increase characteristic extraction ability of the prediction model, wherein each of the plurality of heads has independent W_{Q}, W_{K} and W_{V}, and a formula for calculating the attention MultiHead(Q, K, V) is expressed as follows:
$$MultiHead ( Q , K , V ) = Concat ( {head}_{1} , … , {head}_{h} ) {W}_{O} \qquad ( 12 )$$
$${head}_{h} = Attention ( {QW}_{Q}^{h} , {KW}_{K}^{h} , {VW}_{V}^{h} ) \qquad ( 13 )$$
wherein h represents a number of the plurality of heads, and W_{O} represents a linearity transformation matrix; and Concat(⋅) represents a concatenating operation;
S2.2.2, performing, by the feedforward neural network, non-linearity transform on the attention output by the multi-head self-attention mechanism, wherein the feedforward neural network comprises a first fully connected network layer, a second fully connected network layer, and a rectified linear unit (ReLU) activation function connected between the first fully connected network layer and the second fully connected network layer, and the non-linearity transform is expressed as follows:
$$FFN ( x ) = {W}_{2} ( ReLU ( {W}_{1} x + {b}_{1} ) ) + {b}_{2} \qquad ( 14 )$$
wherein W₁ represents a weight matrix of the first fully connected network layer, and b₁ represents a bias vector of the first fully connected network layer; and W₂ represents a weight matrix of the second fully connected network layer, and b₂ represents a bias vector of the second fully connected network layer;
S2.2.3, in the residual connection and normalization, adding residual connection and layer normalization after each sublayer to obtain an output Output as follows:
$$Output = LayerNorm ( x + SubLayer ( x ) ) \qquad ( 15 )$$
wherein LayerNorm(⋅) represents layer normalization calculation; and SubLayer(x) represents an output of the multi-head self-attention mechanism or the feedforward neural network; and
S2.3, in the fully connected layers, inputting the target-dimension feature representation Z_{L} generated by the Transformer encoder into the fully connected layers, performing linearity transform on the target-dimension feature representation Z_{L} in one or multiple layers of the fully connected layers to output the probability distribution of the risk grades of the coal burst, and outputting, by using the Softmax activation function, a risk grade with a maximum probability in the probability distribution of the risk grades of the coal burst as the prediction result as follows:
$${p}_{c} = softmax ( {W}_{d} ( x ) + {b}_{d} ) \qquad ( 16 )$$
wherein W_{d} represents a weight matrix of a d^{th} fully connected layer of the fully connected layers, and b_{d} represents a bias vector of the d^{th} fully connected layer; and p_{c} represents a prediction probability of a risk grade c of the coal burst.

5. The method for constructing the prediction model of the coal burst based on multimodal data as claimed in claim 2, wherein the step S3 specifically comprises:
normalizing the risk grades RL of the coal burst into an [0,1] interval, and classifying the mining information data, the geological structure data and the prediction result into the [0,1] interval, thereby ultimately evaluating the risk grades of the coal burst, comprising:
classifying the mining information data by using comprehensive index method classification criteria, where a specific criterion for classifying some factors can be modified according to an actual situation; and calculating an influence factor Wₑ of the mining information data as follows:
$${W}_{e} = \frac{{\sum }_{i = 1}^{8} {W}_{e}^{1}}{{\sum }_{i = 1}^{8} {( {W}_{e}^{1} )}_{max}} [ \qquad ( 17 )$$
classifying the geological structure data by using the comprehensive index method classification criteria, and analyzing geological structures affected by the geological data and the mining data to obtain an influence factor of the geological data and an influence factor of the mining data as follows:
$${W}_{g 1} = \frac{{\sum }_{i = 1}^{7} {W}_{1}^{i}}{{\sum }_{i = 1}^{7} {( {W}_{1}^{i} )}_{max}} [ ; \qquad ( 18 )$$
$${W}_{g 2} = \frac{{\sum }_{i = 1}^{11} {W}_{2}^{i}}{{\sum }_{i = 1}^{2} {( {W}_{2}^{i} )}_{max}} [$$
wherein W_{g1} represents the influence factor of the geological data, and W_{g2} represents the influence factor of the mining data;
selecting a maximum comprehensive index value of the geological data and the mining data as an influence factor W_{g} of the geological structure data as follows:
$${W}_{g} = max \{ {W}_{g 1} , {W}_{g 2} \} \qquad ( 19 )$$
using a risk grade with a maximum probability as an influence factor Wₘ of the prediction result, comprising:
determining the risk grade with the maximum probability output by the prediction model;
classifying the maximum probability into five sub-grades, and determining four risk grade ranges corresponding to each of the five sub-grades of the maximum probability, to thereby obtain the influence factor Wₘ of the prediction result; wherein a range of the maximum probability (p_{c})ₘₐₓ of the risk grade output by the prediction model is (0.25,1], different influencing factors Wₘ of the prediction result are constructed according to a distribution characteristic of the probability output by the prediction model to show a degree of risk of different risk grades, and each of the risk grades is configured to reflect a probability output result of the prediction model, and is also configured to improve classification accuracy of the risk grades, thereby achieving a more reliable risk evaluation of the coal burst;
determining a weight of each of the influence factor Wₑ of the mining information data, the influence factor W_{g} of the geological structure data and the influence factor Wₘ of the prediction result as aₑ, a_{g} and aₘ respectively, wherein aₑ+a_{g}+aₘ=1;
considering dynamic changes in the weight of each of the influence factor Wₑ of the mining information data, the influence factor W_{g} of the geological structure data and the influence factor Wₘ of the prediction result during the mining process, calculating a probability distribution of each of the mining information data, the geological structure data and the prediction result by using time windows the same as that of the precursor pattern sequences as follows:
$${P}_{kl} = \frac{{W}_{k} ( l )}{{\sum }_{l = 1}^{b} {W}_{k} ( l )} , k ∈ \{ e , g , m \} , l ∈ 1 , 2 , … , b \qquad ( 20 )$$
wherein Wₖ(l) represents an influence factor of the mining information data, an influence factor of the geological structure data and an influence factor of the prediction result of an l^{th} sample of samples; and b represents a total number of the samples; and e represents the mining information data, g represents the geological structure data, and m represents the prediction result;
calculating an information entropy of each of the mining information data, the geological structure data and the prediction result as follows:
$${E}_{k} = - \frac{1}{ln ( b )} {\sum }_{l = 1}^{b} {P}_{kl} ln ( {P}_{kl} ) , k ∈ \{ e , g , m \} \qquad ( 21 )$$
wherein Eₖ represents an information entropy of k^{th} data; and ln(b) represents a normalization coefficient of the information entropy;
calculating the weight of each of the mining information data, the geological structure data and the prediction result as follows:
$${α}_{k} = \frac{1 - {E}_{k}}{{\sum }_{k = 1}^{3} ( 1 - {E}_{k} )} , k ∈ \{ e , g , m \} \qquad ( 22 )$$
wherein aₑ represents the weight of the influence factor Wₑ of the mining information data, a_{g} represents the weight of the influence factor W_{g} of the geological structure data, and aₘ represents the weight of the influence factor Wₘ of the prediction result; and
calculating the risk grade RL of the coal burst in a prediction time interval as follows:
$$RL = {α}_{e} {W}_{e} + {α}_{g} {W}_{g} + {α}_{m} {W}_{m} . \qquad ( 23 )$$
